(19) United States
(12) Patent Application Publication
(10) Pub. No.: US 2021/0114228 A1
(43) Pub. Date: Apr. 22, 2021

(54) ACOUSTIC VIBRATION DETECTION DEVICE AND REMOTE CONTROL VEHICLE

(71) Applicant: SZ DJI TECHNOLOGY CO., LTD., Shenzhen (CN)

(72) Inventors: Liang LI, Shenzhen (CN); Yiming CHEN, Shenzhen (CN); Zheng KUANG, Shenzhen (CN)

(21) Appl. No.: 17/135,935

(22) Filed: Dec. 28, 2020

Related U.S. Application Data
(63) Continuation of application No. PCT/CN2018/093685, filed on Jun. 29, 2018.

(51) Int. Cl. B25J 13/00; B25J 19/02; B25J 9/00

(52) U.S. Cl. CPC B25J 13/003; B25J 13/006; B25J 9/0015; B25J 9/0012; B25J 19/026

(57) ABSTRACT

A remote control vehicle includes a vehicle body and an acoustic vibration detection device. The vehicle body includes a protection cover. The acoustic vibration detection device is located at a side of the protection cover away from an external surface of the protection cover and configured to detect acoustic vibration generated when the protection cover is hit by an external object. The acoustic vibration detection device includes a housing body, a damping assembly, and an acoustic sensor. The housing body includes a chamber. The acoustic sensor includes a microphone arranged in the chamber through the damping assembly.

### CROSS-REFERENCE TO RELATED APPLICATION

This application is a continuation of International Application No. PCT/CN2018/093685, filed Jun. 29, 2018, the entire content of which is incorporated herein by reference.

### TECHNICAL FIELD

The present disclosure generally relates to the acoustics field and, more particularly, to an acoustic vibration detection device and a remote control vehicle.

### BACKGROUND

A microphone can convert external sound and vibration signals to electrical signals through a sound-electric conversion process to obtain and recognize the sound.

Currently, in some vehicles or other automatic control devices, to sense vibration and impact from outside, the microphone is usually arranged to perform detection. When an object hits the vehicle, a vibration of a sound wave is transferred to the microphone and is detected and recognized by the microphone. In general, the microphone can convert a vibration of an internal diaphragm to a capacitance or inductance change. When external sound wave vibration exists, the sound wave can enter the microphone and push the diaphragm to deform. Thus, the capacitance or inductance of the microphone changes to generate a voltage that changes with the sound wave. As such, the change of the sound wave can be recognized by reading the voltage.

However, when the microphone collects the sound wave vibration generated by the external impact, since the energy of the external vibration is large, the vibration can be transferred to the microphone and cause the internal diaphragm of the microphone to generate an excessive vibration amplitude. As such, the original information is lost. Therefore, the sound cannot be accurately detected and recovered.

### SUMMARY

Embodiments of the present disclosure provide a remote control vehicle includes a vehicle body and an acoustic vibration detection device. The vehicle body includes a protection cover. The acoustic vibration detection device is located at a side of the protection cover away from an external surface of the protection cover and configured to detect acoustic vibration generated when the protection cover is hit by an external object. The acoustic vibration detection device includes a housing body, a damping assembly, and an acoustic sensor. The housing body includes a chamber. The acoustic sensor includes a microphone arranged in the chamber through the damping assembly.

### BRIEF DESCRIPTION OF THE DRAWINGS

FIG. 1 is a schematic structural diagram of an acoustic vibration detection device according to some embodiments of the present disclosure.

FIG. 2 is a schematic top view of the acoustic vibration detection device in FIG. 1.

FIG. 3 is a schematic structural diagram of a flexible sleeve according to some embodiments of the present disclosure.

FIG. 4 is a schematic structural diagram of another acoustic vibration detection device according to some embodiments of the present disclosure.

FIG. 5 is a schematic perspective diagram of a remote control vehicle according to some embodiments of the present disclosure.

### REFERENCE NUMERALS

1—Housing body, 3—Acoustic sensor, 11—Chamber, 12—Bottom housing, 13—Upper cover, 21—Flexible sleeve, 22—Second flexible damping member, 31—Microphone, 32—Circuit board, 100—Remote control vehicle, 101—Vehicle body, 103—Protection cover, 211—Accommodation member, 212—Flexible deformation member, 213—Mounting member, 321—Mounting hole, 2131—Snap slot, 103a—Impact surface, 212a—First connection segment, 212b Second connection segment.

### DETAILED DESCRIPTION OF THE EMBODIMENTS

To make purposes, technical solutions, and advantages of embodiments of the present disclosure clearer, the technical solutions of embodiments of the present disclosure are described in detail in connection with the accompanying drawings. Described embodiments are some embodiments of the present disclosure, not all embodiments. Based on embodiments of the present disclosure, all other embodiments obtained by those of ordinary skill in the art without creative efforts are within the scope of the present disclosure.

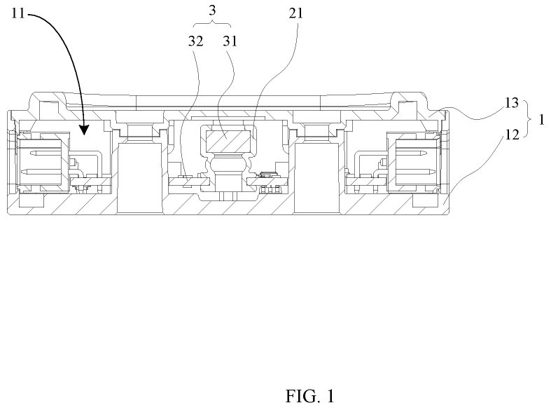

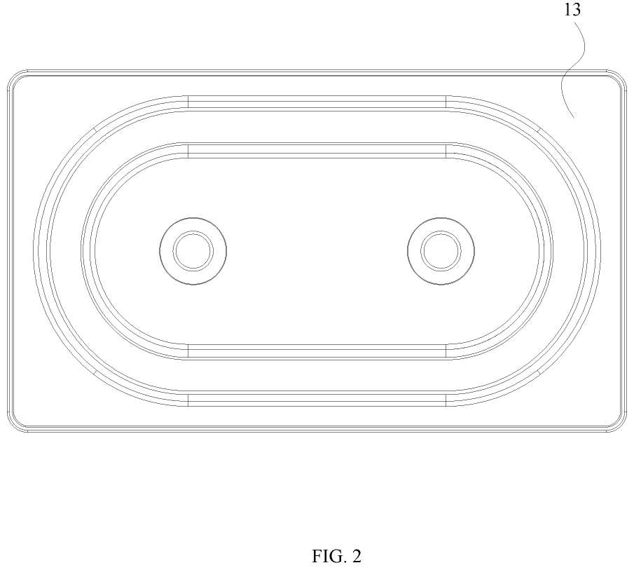

FIG. 1 is a schematic structural diagram of an acoustic vibration detection device according to some embodiments of the present disclosure. FIG. 2 is a schematic top view of the acoustic vibration detection device in FIG. 1. As shown in FIG. 1 and FIG. 2, the acoustic vibration detection device of embodiments of the present disclosure includes a housing body 1, a damping assembly, and an acoustic sensor 3. The housing body includes a chamber 11. The acoustic sensor 3 includes a microphone 31. The microphone 31 is arranged in the chamber 11 through the damping assembly.

In some embodiments, the acoustic vibration detection device may be arranged in an independent device or equipment and configured to detect an external impact or vibration received by the device or equipment. To detect an acoustic vibration from the outside, the acoustic vibration detection device includes the acoustic sensor 3, which can collect the sound. When the device receives the external impact or vibration, a certain sound may be generated correspondingly. Thus, the acoustic vibration detection device may detect a sound wave generated due to the impact or vibration through the acoustic sensor 3 and convert the sound wave into an electrical signal for subsequent processing and calculation. The acoustic sensor 3 may perform sound collection and conversion between the sound wave and the electrical signal through the microphone 31. In addition, the acoustic sensor 3 may include other circuits or elements.

To arrange the microphone 31, the acoustic vibration detection device further includes a housing body 1. The housing body 1 may have a hollow structure having the chamber 11. Thus, the microphone 31 may be arranged in the chamber 11 and protected by the housing wall of the housing body 1. In one aspect, the housing body 1 may directly or indirectly receive external impact, collision, or vibration and transmit the sound wave to the microphone 31. Thus, the microphone 31 may be prevented from directly receiving the external impact and vibration. In another aspect, the housing body 1 may shield at the outside of the microphone 31 to isolate it from extern water vapor and dust. Thus, the microphone 31 may not be affected by the external environment.

When the microphone 31 is configured to detect an everyday sound, for example, human voice or other sounds with low decibels, the microphone may have an open structure to increase the sensitivity of the microphone. However, in some embodiments, the microphone 31 of the acoustic vibration detection device may be configured to detect the strong impact and vibration from the outside by detecting the sound wave. The vibration caused by the impact may be relatively strong. Since the impact may bring excessive energy, after the sound wave of a high decibel (e.g., larger than 130 decibels) is transmitted to the microphone 31, the internal diaphragm of the microphone 31 may generate an excessive vibration amplitude, which may exceed an original linear interval. Thus, the signal detected by the microphone 31 may have a blurred relationship with an original sound intensity, which may cause a portion of information to be lost and reduce discrimination of the original sound intensity and reproduction of the sound. As such, the original acoustic vibration may be difficult to be accurately recovered. To prevent the sound wave vibration of the high decibel from exceeding the original linear interval of the microphone 31 to damage and reduce the lifetime of the internal elements such as the diaphragm of the microphone 31, the acoustic vibration transmitted to the microphone 31 may need to be reduced. Therefore, in some embodiments, the damping assembly is arranged between the microphone 31 and the housing body 1. The damping assembly may filter and eliminate a portion of the vibration and the impact from the housing body. As such, the amount of the vibration and sound transmitted to the microphone 31 may be reduced, which may not excite the diaphragm to generate a large vibration amplitude. Thus, the microphone 31 may maintain in the original linear interval to accurately detect the vibration of the sound wave.

In some embodiments, to weaken the impact and vibration from the outside and prevent the microphone 31 from being damaged due to the excessive strong impact and vibration, the housing body 1 of the acoustic vibration detection device may be a sealed housing body. As such, an external acoustic vibration wave cannot directly enter the inside of the sealed housing body, but only indirect vibration propagation may be realized by using the housing wall of the housing body 1 as a propagation medium. Thus, the acoustic vibration wave may be reflected and refracted due to encountering different propagation media, and most of the sound waves may be reflected. Thus, the impact and vibration may be greatly reduced to cause relatively few acoustic vibration waves to enter the microphone 31. As such, the excessive vibration amplitude of the diaphragm of the microphone may be avoided, which may be beneficial for the microphone 31 to accurately detect the sound wave vibration.

To reduce the vibration transmitted from the housing body 1 to the microphone 31, the damping assembly may include a plurality of different structures and implementations, which are described as follows.

In some embodiments, the acoustic sensor 3 further includes a circuit board 32. The microphone 31 is arranged at the circuit board 32 and is electrically connected to the circuit board 32.

In some embodiments, to arrange the microphone 31 and facilitate the electrical connection of the microphone 31 and other circuit elements, a circuit board 32 is arranged in the acoustic sensor 3. The circuit board 32 may be configured as an arrangement basis of the microphone 31 to arrange the microphone 31 and other circuits or devices at the circuit board 32. As such, the circuit board 32 physically carries the microphone 31 and is electrically connected to other devices. The microphone 31 may be arranged at the circuit board 32 by a fixing structure. A lead of the microphone 31 may be connected to a lead or a solder joint of the circuit board 32. Thus, the circuit board 32 may provide power to the microphone 31 through the other devices and transmit the electrical signal detected by the microphone 31 to the other devices to perform subsequent calculation and processing.

In some embodiments, the circuit board 32 may include a printed circuit board (PCB). Thus, the circuit board 32 may have sufficient rigidity and bearing capacity, which may provide a rigid fixation and support basis for the microphone 31 to ensure that the microphone 31 is located at a correct position.

In addition, in the acoustic vibration detection device, one or more circuit boards may be included. When more than one circuit board is included, the circuit board 32 may refer to the circuit where the microphone 32 is located.

Since the microphone 31 is arranged at the circuit board 32, correspondingly, the damping assembly may include a plurality of different arrangement manners and arrangement positions.

In some embodiments, the damping assembly may be arranged between the microphone 31 and the circuit board 32. Thus, the circuit board 32 and the housing body 1 of the acoustic vibration detection device may be fixedly connected. The microphone 31 may be arranged at the circuit board 32 by the damping assembly. The damping assembly may reduce and filter out a large portion of the vibration and impact transmitted from the circuit board 32 to the microphone 31.

In some embodiments, to be connected to the microphone 31, the damping assembly may include a first flexible damping member. The first flexible damping member may be arranged at the circuit board 32, and the microphone 31 may abut against the first flexible damping member. Since the first flexible damping member may have a certain flexibility and elasticity, when the vibration and the impact are transmitted from the circuit board 32 to the first flexible damping member, a large portion of the energy of the vibration and the impact may be absorbed by the deformation of the first flexible damping member. Since the energy of the sound wave and the vibration transmitted from the first flexible damping member to the microphone 31 is relatively small, the sound wave may be prevented from exceeding the range or the linear interval of the microphone 31. As such, the microphone 31 may be ensured to normally collect and detect the sound.

The microphone 31 may abut against the first flexible damping member. Thus, the microphone 31 and the first flexible damping member may be ensured to be in tight contact to realize a reliable flexible connection.

The first flexible damping member may include a plurality of different structures and forms. The first flexible damping member and the microphone 31 may have a plurality of different connection relationships. In some embodiments, the first flexible damping member may include a hollow flexible sleeve 21. Thus, the first flexible damping member may enclose at the outer side of the microphone 31 to provide protection and damping for the microphone 31 in a plurality of directions.

Further, when the first flexible damping member includes the hollow flexible sleeve 21, the first flexible damping member may enclose different portions of the microphone 31. In some embodiments, to provide sufficient damping for the microphone 31 while ensuring the normal sound detection function of the microphone 31, the sleeve 21 may enclose the outside of other outer surfaces except for the sound detection surface of the microphone 31. Thus, the sound detection surface at the front of the microphone 31 may still be exposed outside of the sleeve 21, which may contact the external air normally and collect the vibration of the sound wave from the outside. However, other surfaces of the microphone 31 may be covered by the flexible sleeve 21. As such, the flexible sleeve 21 may provide sufficient protection and damping for the microphone 31 to effectively reduce the impact and vibration transmitted from the circuit board 32 to the microphone 31.

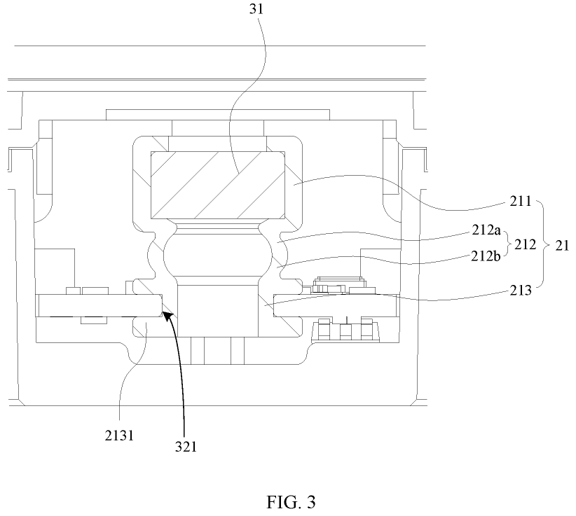

To realize the damping function of the flexible sleeve 21, on one aspect, damping may be realized by using the material feature of the flexible sleeve 21. On another aspect, the damping may be realized by designing the flexible sleeve as a structure that can generate a certain deformation. FIG. 3 is a schematic structural diagram of a flexible sleeve according to some embodiments of the present disclosure. In some embodiments, as shown in FIG. 3, the flexible sleeve 21 includes an accommodation member 211 at a top of the flexible sleeve 21 and a flexible deformation member 212 below the accommodation member 211. The accommodation member 211 includes a cavity configured to accommodate the microphone 31. The flexible deformation member 212 may generate flexible deformation.

The accommodation member 211 of the flexible sleeve 21 may accommodate the microphone 31 to limit and position the microphone 31. The flexible deformation member 212 may be connected to the accommodation member 211, and the flexible deformation member 212 may generate a certain elastic deformation with the impact and vibration. As such, the vibration energy from the outside may be absorbed by using the elastic deformation to reduce the vibration transmitted to the microphone 31.

To realize the flexible deformation of the flexible deformation member 212, the flexible deformation member 212 may include a plurality of different elastic structures. In some embodiments, the flexible deformation member 212 includes a first connection segment 212a and a second connection segment 212b. A length direction of the first connection segment 212a and a length direction of the second connection segment 212b interact with each other such that the first connection segment 212a and the second connection segment 212b form a foldable or extendable bending structure.

In some embodiments, the first connection segment 212a and the second connection segment 212b of the flexible deformation member 212 may be connected in sequence along the length direction of the flexible deformation member 212, that is, a height direction of the flexible sleeve 21. The first connection segment 212a and the second connection segment 212b may have different extension directions. As such, when the flexible sleeve 21 receives the impact and vibration from the outside, the impact and the vibration may be transmitted along the height direction of the flexible sleeve 21. Then, a crossing angle between the first connection segment 212a and the second connection segment 212b may change, which may be presented as folding of the flexible deformation member 212 along the length direction. As such, the energy of the impact and the vibration may be absorbed by using the deformation of the first connection segment 212a and the second connection segment 212b. After the vibration and the impact are eliminated, the first connection segment 212a and the second connection segment 212b may recover to the original crossing angle by using their own elasticity, which may be represented by the extension of the flexible deformation member 212 along the length direction. Thus, the flexible deformation member 212 may perform folding or extension according to the received vibration or impact to reduce the vibration energy transmitted to the microphone 31.

In the flexible deformation member 212, the flexible deformation member 212 may include a two-segment format and be described as an example including the first connection segment 212a and the second connection segment 212b. In addition, the flexible deformation member 212 may also include more connection segments, and adjacent connection segments may cross with each other. As such, a structure with a larger deformation and a better vibration energy absorption may be formed, which is not repeated here.

In some embodiments, to fix the flexible sleeve 21 at the circuit board 32, the flexible sleeve 21 further includes a mounting member 213 configured to connect to the circuit board 32. The mounting member 213 is connected to the flexible deformation member 212. The mounting member 213 may be connected to the circuit board 32 by a plurality of manners.

In some embodiments, to fix the flexible sleeve 21 at the circuit board 32, the flexible sleeve 21 further includes a mounting member 213 connected to the circuit board 32. The mounting member 213 is connected to the flexible deformation member 212. The mounting member 213 may be connected to the circuit board 32 by a plurality of manners.

In some embodiments, the circuit board 32 includes a mounting hole 321. The mounting member 213 passes through and is fixed in the mounting hole 321 to realize the connection between the flexible sleeve 21 and the circuit board 32. The mounting hole 321 may have a defined position and may position the mounting member 213. A wall of the mounting hole 321 may limit and support the mounting member 213 to effectively fix the mounting member 213.

Correspondingly, in some embodiments, to be fixed in the mounting hole 321, the mounting member 213 further includes a snap slot 2131. The snap slot 2131 is arranged at an edge of the mounting hole 321. As such, two sides of the snap slot 2131 clamp at up and down sides of the circuit board 32, respectively. The snap slot 2131 and the edge of the mounting hole 321 abut against and snap with each other. Thus, the mounting member 213 may be snaped and connected to the mounting hole 321.

In some embodiments, the snap slot 2131 may include a plurality of different structures. For example, in some embodiments, the snap slot 2131 may include a ring-shaped snap slot. The snap slot 2131 is snapped and arranged at the circumferential edge of the mounting hole 321. Thus, the snap slot 2131 may be snapped and connected to the mounting hole 321 at the circumstance of the flexible sleeve 21. As such, the snap connection between the snap slot 2131 and the mounting hole 321 may be relatively stable.

The mounting member 213, the flexible deformation member 212, and the accommodation member 211 may be divided structures independent of each other and may be connected to each other by snap connection or sleeve connection, or may be an integral structure. Since the flexible sleeve 21 may be integrally formed by the flexible material, the mounting member 213, the flexible deformation member 212, and the accommodation member 211 may be connected to each other in an integrated structure connected to each other. Thus, the processing and formation of the flexible sleeve 21 may be relatively simple, and the formed structure may be relatively reliable.

In some embodiments, the first flexible damping member such as the flexible sleeve 21 may be made of a plurality of different flexible materials. For example, in some embodiments, the first flexible damping member may include a silicon member. The silicon member may have good elasticity and chemical stability. Thus, the silicon member may stably and reliably support the microphone 31 and filter and attenuate the vibration and impact from the circuit board 32.

In addition, since the microphone 31 is fixed by the first flexible damping member such as the flexible sleeve 21, the microphone 31 may generate a certain displacement relative to the circuit board 32. Thus, in some embodiments, to ensure the normal electrical connection between the circuit board 32 and the microphone 31, the microphone 31 and the circuit board 32 may be electrically connected via a soft connection wire. As such, when the displacement is generated between the microphone 31 and the circuit board 32, the soft connection wire may generate a certain deformation with the relative displacement between the microphone 31 and the circuit board 32. Thus, the normal and reliable electrical connection may be ensured between the microphone 31 and the circuit board 32.

Besides being located between the microphone 31 and the circuit board 32, the damping assembly may be located at other positions. In some other embodiments, the damping assembly may be arranged between the circuit board 32 and the housing body 1. Thus, the circuit board 32 and the microphone 31 that is arranged at the circuit board 32 both may be connected to the housing body 1 by the damping assembly. Therefore, the damping support of the damping assembly may be obtained, and the vibration transmitted to the microphone 31 may be reduced.

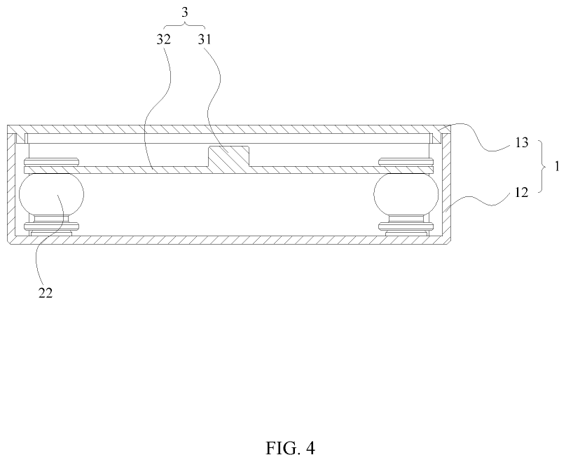

FIG. 4 is a schematic structural diagram of another acoustic vibration detection device according to some embodiments of the present disclosure. As shown in FIG. 4, in some embodiments, to connect the circuit board 32 and the housing body 1, the damping assembly includes at least one second flexible damping member 22. An end of the second flexible damping member 22 abuts against the circuit board 32. Another end of the second flexible damping member 22 is fixed at the inner wall of the housing body 1. As such, the circuit board 32 is connected to the inner wall of the housing body 1 by the second flexible damping member 22. When the external impact and vibration are transmitted to the housing body 1, the second flexible damping member 22 may filter out a part of the vibration by using its own elastic deformation to reduce vibration impact received by the circuit board 32.

In some embodiments, the second flexible damping member 22 may be arranged at a side of the circuit board 32 away from the microphone 31. Thus, when the circuit 32 is connected to the housing body 1 by the second flexible damping member 22, the microphone 31 at the circuit board 32 may be located on a side opposite to the second flexible damping member 22, that is, a side of the circuit board 32 away from the housing body 1. Thus, the microphone 31 may be relatively far away from the inner wall of the housing body 1. Therefore, a relatively large space may surround the microphone 31 to facilitate the microphone 31 to collect and pick up surrounding sound waves.

One or more second flexible damping members 22 may be included. In some embodiments, since the circuit board 32 may have a relatively large area, to support the circuit board 32 and cause the circuit board 32 to maintain a relatively stable attitude, a plurality of second flexible damping members 22 may be included and abut against different portions of the circuit board 32. As such, the plurality of flexible damping members 22 may support at the different positions of the circuit board 32 to cause the circuit board 32 to obtain multi-point supports to stably maintain its attitude.

Since the second flexible damping member 22 may be configured to reduce the vibration and the impact for the microphone 31, when the plurality of second flexible damping members 22 are included, the plurality of second flexible damping members 22 may be symmetrically arranged relative to the microphone 31. As such, the second flexible damping members 22 may form position-symmetrical support points at different sides of the microphone 31. Thus, when the external impact and vibration are transmitted to the inside of the housing body 1, the symmetrically arranged second flexible damping members 22 may generate synchronous elastic deformations to evenly attenuate the vibration and effectively maintain the stability of the circuit board 32.

To form the relatively stable support, the number of the second flexible damping members 22 may be at least three. The at least three second flexible damping members 22 may not be colinear. Thus, the three or more than three second flexible damping members 22 may be configured as vertexes of a triangle or a polygon to support the circuit board 32 together.

In some embodiments, when the number of the second flexible damping members 22 is three or more than three, projection of the second flexible damping members 22 at the circuit board 32 may around the outside of the microphone 31. As such, the second flexible damping members 22 may be circumferentially around the microphone 31 to perform vibration reduction and support, which may effectively weaken the impact and vibration transmitted to the microphone 31. Thus, the microphone 31 may be ensured to perform a normal sound collection operation.

In some embodiments, since the circuit board 32 may include the relatively large area, to reduce the tilting phenomenon of the circuit board 32 due to the external impact and vibration, the second flexible damping members 22 may be located at the edge area of the circuit board 32. As such, the distribution area of the second flexible damping members 22 may be scattered and close to the edge of the circuit board 32. Therefore, the second flexible damping members 22 may provide relatively stable support for the circuit board 32 to cause the circuit board 32 to maintain the stable attitude when receiving the external impact and vibration.

Similar to the first flexible damping member, the second flexible damping member 22 may include a plurality of structures and shapes, for example, an elastic support arm or an elastic beam. In some embodiments, the second flexible damping member 22 may include a ball-shaped damping member. Thus, the second flexible damping member 22 may have a ball shape and be made of a material that can generate elastic deformation. As such, when the external vibration and the impact are transmitted to the second flexible damping member 22 through the housing body 1, the second flexible damping member 22 may absorb and weaken the vibration through the ball-shaped structure to filter out the vibration transmitted from the housing body 1. In some embodiments, when the second flexible damping member 22 includes the ball-shaped damping member, the specific structure and working principle may be that, for example, the second flexible damping member 22 may include a damping ball that has a ball shape and can generate the elastic deformation and a position limiting connection rod that is arranged at and passes through the inside of the damping ball, which is not repeated here.

In addition, similar to the first flexible damping member, the second flexible damping member 22 may also include a silicon member. The silicon member may have good elasticity and chemical stability. Thus, the silicon member may stably and reliably support the microphone 31 and filter and weaken the vibration and impact from the circuit board 32. The second flexible damping member 22 may also be made of a plurality of different flexible or elastic materials, for example, rubber or other elastic materials, which are not repeated here.

In some embodiments, to arrange the members, such as the microphone 31, the circuit board 32, and the damping assembly, inside the housing body 1, the housing body 1 includes a bottom housing 12 and an upper cover 13. The bottom housing 12 includes the chamber 11 having an opening. The upper cover 13 is arranged at the opening. Since the housing body 1 includes the openable upper cover 13, the members, such as the microphone 31, the circuit board 32, and the damping assembly, may be mounted inside the chamber of the bottom housing 12 through the opening of the bottom housing 12, and the upper cover 13 may be arranged at the opening to seal the housing body 1.

In some embodiments, the upper cover 13 of the housing body 1 may be located on the side facing the microphone 31. Thus, the upper cover 13 of the housing body 1 may face the side of the external impact and vibration, which may cause the external sound wave to be directly transmitted to the microphone 31 through the housing body 1 to ensure the microphone 31 to accurately collect and pick up the sound.

In some other embodiments, the upper cover 13 may be located on a side away from the microphone 31. Thus, the side of the housing body 1 away from the upper cover 13 may face the side of the external impact and vibration. As such, the microphone 31 may also be ensured to normally collect and pick up the sound.

In addition, the microphone 31 may include other positions in the housing body 1, for example, a sidewall facing the housing body 1, which is not limited here.

In some embodiment, the acoustic vibration detection device includes the housing body, the damping assembly, and the acoustic sensor. The housing body includes the chamber. The acoustic sensor includes the microphone. The microphone is arranged in the chamber by the damping assembly. As such, the damping assembly of the acoustic vibration detection device may filter and reduce the vibration and impact transmitted to the microphone to cause the microphone to accurately detect the sound wave vibration.

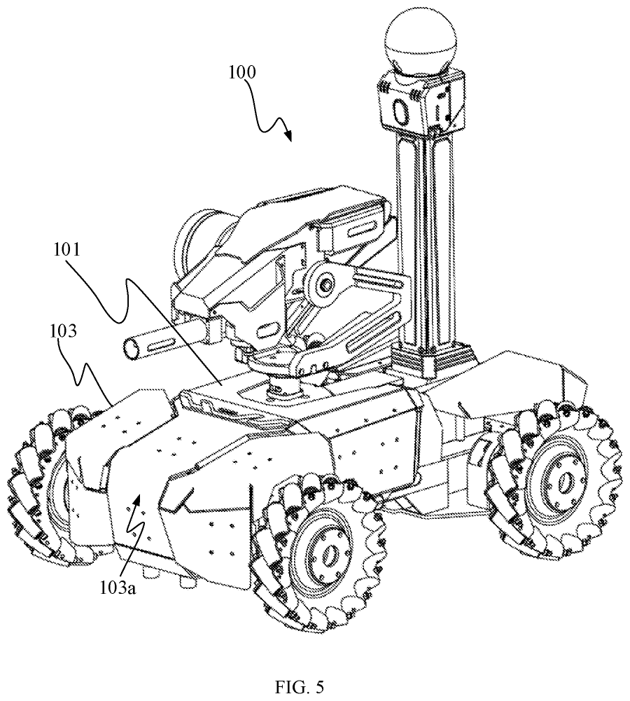

In addition, FIG. 5 is a schematic perspective diagram of a remote control vehicle 100 according to some embodiments of the present disclosure. As shown in FIG. 5, the remote control vehicle 100 consistent with embodiments of the present disclosure includes the acoustic vibration detection device. In some embodiments, the remote control vehicle 100 includes a vehicle body 101 and the acoustic vibration detection device. A protection cover 103 is arranged at an external surface of the vehicle body 101. An external surface of the protection cover 103 is an impact surface 103a. The acoustic vibration detection device is located on a side of the protection cover 103 away from the impact surface 103a and may be configured to detect the acoustic vibration generated when the protection cover 103 is hit by an external shooting object. The specific structure, function, and working principle of the acoustic vibration detection device are described in detail above, which are not repeated here.

In some embodiments, the remote control vehicle may be configured to compete with other remote control vehicles and may obtain scoring and competition effects by shooting bullets at each other. When the remote control vehicle is shot by the bullets, to perform detection and statistic on the impact times of the remote control vehicle by the bullets, acoustic vibration generated due to the impact or collision of the external shooting objects may be detected by the acoustic vibration detection device, and the impact times may be calculated according to the times of the acoustic vibration.

To bear the impact of the external bullets or other shooting objects, the protection cover may be arranged at the external surface of the vehicle body of the remote control vehicle. The external surface of the protection cover may be configured to bear the impact of the shooting objects and may be referred to as the impact surface. The acoustic vibration detection device may be arranged at the inner side of the protection cover. Thus, when the impact surface of the protection cover receives the impact of the external shooting objects, the generated vibration may be transmitted to the acoustic vibration detection device at the inner side of the protection cover through the protection cover. Then, the electret microphone arranged in the acoustic vibration detection device may pick up and detect the sound wave vibration signal generated by the impact and transmit the signal to a circuit such as a subsequent processor to perform the determination and statistic on the impact times.

In some embodiments, the sound detection surface of the microphone of the acoustic vibration detection device may be arranged to face the impact surface. As such, a sound detection direction of the microphone may be consistent with the transmission direction of the sound wave. Thus, the acoustic vibration detection device may effectively detect the sound wave vibration to improve the accuracy and reliability of sound detection and recognition.

In some embodiments, the remote control vehicle includes the vehicle body and the acoustic vibration detection device. The protection cover is arranged at the external surface of the vehicle body. The external surface of the protection cover is the impact surface. The acoustic vibration detection device is located on the side of the protection cover away from the impact surface and is configured to detect the acoustic vibration generated when the protection cover is hit by the external shooting objects. The acoustic vibration detection device includes the housing body, the damping assembly, and the acoustic sensor. The housing body includes the chamber. The acoustic sensor includes the microphone. The microphone is arranged in the chamber by the damping assembly. As such, the remote control vehicle may filter and reduce the vibration and impact transmitted to the microphone to accurately detect the acoustic vibration. Thus, the parameters such as the impact times may be accurately determined and calculated.

In summary, the above embodiments are only used to illustrate the technical solutions of the present disclosure, but not to limit it. Although the present disclosure has been described in detail with reference to embodiments, those of ordinary skill in the art should understand that modification may still be made to the technical solutions described in embodiments, or equivalent replacement may still be made to some or all of the technical features. These modifications or replacements do not make the essence of the corresponding technical solutions depart from the scope of the technical solutions of embodiments of the present disclosure.

What is claimed is:

1. A remote control vehicle comprising:
a vehicle body including a protection cover; and
an acoustic vibration detection device located at a side of the protection cover away from an external surface of the protection cover and configured to detect acoustic vibration generated when the protection cover is hit by an external object, the acoustic vibration detection device including:
a housing body including a chamber;
a damping assembly; and
an acoustic sensor including a microphone arranged in the chamber through the damping assembly.

2. The vehicle of claim 1, wherein the housing body includes a sealed housing body.

3. The vehicle of claim 1, wherein:
the acoustic sensor further includes a circuit board; and
the microphone is arranged at the circuit board and electrically connected to the circuit board.

4. The vehicle of claim 3, wherein the damping assembly is arranged between the microphone and the circuit board.

5. The vehicle of claim 4, wherein:
the damping assembly includes a flexible damping member arranged at the circuit board; and
the microphone abuts againsts against the flexible damping member.

6. The vehicle of claim 5, wherein the flexible damping member includes a hollow flexible sleeve.

7. The vehicle of claim 6, wherein the flexible sleeve encloses outside of external surfaces of the microphone other than a sound detection surface.

8. The vehicle of claim 6, wherein the flexible sleeve includes:
an accommodation member at a top of the flexible sleeve and including a cavity configured to accommodate the microphone; and
a flexible deformation member below the accommodation member and configured to generate flexible deformation.

9. The vehicle of claim 8, wherein:
the flexible deformation member includes a first connection segment and a second connection segment connected to each other; and
length directions of the first connection segment and the second connection segment cross with each other such that the first connection segment and the second connection segment form a foldable and extendable bending structure.

10. The vehicle of claim 8, wherein:
the flexible sleeve further includes a mounting member configured to be connected to the circuit board; and
the mounting member is connected to the flexible deformation member.

11. The vehicle of claim 10, wherein:
the circuit board includes a mounting hole; and
the mounting member passes through and is fixed in the mounting hole.

12. The vehicle of claim 11, wherein the mounting member includes a snap slot snapped at an edge of the mounting hole.

13. The vehicle of claim 12, wherein:
the snap slot includes a ring-shaped snap slot and is snapped at a circumferential edge of the mounting hole.

14. The vehicle of claim 5, wherein the flexible damping member includes a silicon member.

15. The vehicle of claim 4, wherein the microphone and the circuit board are electrically connected to each other via a soft connection wire.

16. The vehicle of claim 3, wherein the damping assembly is arranged between the circuit board and the housing body.

17. The vehicle of claim 16, wherein the damping assembly includes a flexible damping member, an end of the flexible damping member abutting against the circuit board, and another end of the flexible damping member being fixed at an inner wall of the housing body.

18. The vehicle of claim 17, wherein the flexible damping member is arranged at a side of the circuit board away from the microphone.

19. The vehicle of claim 17, wherein the flexible damping member is one of a plurality of flexible damping members of the damping assembly that abut against different positions of the circuit board.

20. The vehicle of claim 19, wherein the plurality of flexible damping members are symmetrically arranged relative to the microphone.

21. The vehicle of claim 20, wherein the plurality of flexible damping members are located in an edge area of the circuit board.

22. The vehicle of claim 19, wherein the plurality of flexible damping members include at least three flexible damping members.

23. The vehicle of claim 22, wherein projections of the at least three flexible damping members at the circuit board surround outside of the microphone.

24. The vehicle of claim 17, wherein the flexible damping member includes a ball-shaped damping member.

25. The vehicle of claim 17, wherein the flexible damping member includes a silicon member.

26. The vehicle of claim 1, wherein the housing body includes:
a bottom housing including the chamber having an opening; and
an upper cover covers the opening.

27. The vehicle of claim 26, wherein:
the upper cover is located at a side facing the microphone or away from the microphone.

28. The vehicle of claim 3, wherein the circuit board includes a printed circuit board (PCB).

29. The vehicle of claim 1, wherein a sound detection surface of the microphone is arranged to face the external surface.
